(19) United States
(12) Patent Application Publication
(10) Pub. No.: US 2025/0388113 A1
(43) Pub. Date: Dec. 25, 2025

(54) METHOD AND DEVICE FOR DETERMINING A CHARGING PROFILE FOR MAXIMIZING CHARGING ENERGY

(71) Applicant: Robert Bosch GmbH, Stuttgart (DE)

(72) Inventors: Christoph Woll, Gerlingen (DE); Martina Maurer, Rutesheim (DE)

(21) Appl. No.: 19/201,203

(22) Filed: May 7, 2025

(30) Foreign Application Priority Data
May 16, 2024 (DE) 10 2024 204 526.8

(51) Int. Cl. B60L 53/62; B60L 53/66; B60L 53/68

(52) U.S. Cl. CPC B60L 53/62; B60L 53/66; B60L 53/68; B60L 2200/36; B60L 2240/545

(57) ABSTRACT

A computer-implemented method for providing an optimized charging profile for a charging process of a vehicle battery of an electric commercial vehicle with a known start time of the charging process and a known charging period. The method includes: providing a starting state of charge at the start of a charging process, a starting battery temperature, and the predetermined charging period; performing an optimization method for ascertaining an optimized charging current curve, wherein the optimization maximizes a charge quantity storable in the vehicle battery within the charging period and satisfies at least one temperature criterion based on a simulated battery temperature curve, wherein the battery temperature curve is simulated using a specified thermal battery model depending on the starting state of charge, the starting battery temperature, and the charging current curve; providing the optimized charging current curve as an optimized charging profile for performing the charging process.

### FIELD

The present invention relates to vehicle batteries which are to be charged with a maximum charging energy within a predetermined charging period. In particular, the present invention relates to the charging of vehicle batteries within a specified charging period while maximizing the charging energy to be charged.

### BACKGROUND INFORMATION

Charging vehicle batteries of electric trucks or other commercial vehicles differs in terms of the timing and speed of charging from charging vehicle batteries for conventional electric vehicles. While drivers of conventional electric vehicles plan to charge the vehicle battery when the vehicle battery has reached a low state of charge, a driver of an electric truck is bound to fixed driving and break times and should deliver their cargo on time. Only comparatively short break times are therefore available to charge the vehicle battery with as much energy as possible in order to be able to complete the rest of the day's driving distance. Charging according to a charging profile, as is generally common for gentle charging in the case of electric vehicles, or charging independent of breaks depending on charging column availability are thus criteria that are irrelevant when charging an electric commercial vehicle due to the short break times.

The aim of the charging process for vehicle batteries of electric commercial vehicles is to charge as much energy as possible within a specified period during a driving break so that the state of charge is sufficient to drive until the next prescribed break. The vehicle battery should be subjected to as little stress as possible, i.e., it should experience as little degradation as possible due to the charging process.

Charging with the highest possible charge supply can only be achieved by fast charging with high charging currents. During fast charging, a very high charge quantity is stored in the battery within a short time, but the high temperatures produced during the charging process require cooling or power reduction in order to avoid damage to the vehicle battery or very rapid degradation. In addition, the vehicle battery is only charged up to a state of charge of 80 to 85% in fast charging mode.

A fast charging process generally causes high degradation of the vehicle battery. It is therefore necessary to provide a suitable charging profile, which makes it possible to drive until the next driving break and during which a maximum battery temperature is not exceeded, for a charging process of an electric commercial vehicle during a driving break. The cooling capacity, the state of charge, and the battery temperature at the start of the charging process are to be taken into account.

### SUMMARY

According to the present invention, a method for performing a charging process for a vehicle battery of an electric commercial vehicle and a corresponding device are provided.

Example embodiments of the present invention are disclosed herein.

According to a first aspect of the present invention, a method for providing an optimized charging profile for a charging process of a vehicle battery of an electric commercial vehicle with a known start time of the charging process and a known charging period is provided. According to an example embodiment of the present invention, the method includes the following steps:
providing a starting state of charge at the start of a charging process, a starting battery temperature, and a predetermined charging period;
performing an optimization method for ascertaining at least one optimized charging current curve, wherein the optimization maximizes a charge quantity storable in the vehicle battery within the charging period and satisfies at least one temperature criterion based on a simulated battery temperature curve, wherein the battery temperature curve is simulated by means of a specified thermal battery model depending on the starting state of charge, the starting battery temperature, and the charging current curve;
providing the at least one optimized charging current curve as an optimized charging profile for performing the charging process.

Various types of electric commercial vehicles are available, such as electric trucks as light commercial vehicles (used for urban transport), medium-duty trucks (used for regional transport), and heavy-duty trucks (used for long-distance transport). The resulting driving distances to be covered per day are between 100 and 700 km, which require battery capacities of approximately 200 to 800 kWh. The battery capacity is characteristic for the different vehicle classes.

Conventionally, the battery management system of today's electric commercial vehicles contains a fixed charging profile that is used for a charging process. This charging profile is predetermined and takes into account not only battery-specific limit values but also aging effects in order to operate the charging profile in an adapted manner. The conventional charging profile specifies a maximum charging current that is reduced when the battery temperature of the vehicle battery reaches or approaches a temperature threshold of a maximum battery temperature. Without sufficient cooling or only with the internal battery cooling, only limited countermeasures can be taken, especially during a charging process with high charging currents, which means that the battery temperature must first cool down before the charging process can begin.

Vehicle batteries are generally monitored by a plurality of calculation models in order to ascertain the current battery state and predict the future behavior of the vehicle battery. For example, a thermal battery model (based on an impedance-based equivalent circuit model of a battery and calculation of the ohmic losses, or based on a calculation model with multidimensional temperature characteristic maps and heat sources through suitable interconnection of 0D/1D models) that can determine the temperature curve of the vehicle battery depending on the load profile, active temperature control (cooling/heating), and ambient temperature, an aging state model that can determine the current and predicted aging state curve, and an electrochemical battery model with which internal battery states can be ascertained are available. The models can model the vehicle battery at the cell level, the module level, or the pack level. This monitoring often takes place in a central unit (cloud) external to the vehicle, the central unit evaluating the operating variable data of the vehicle battery and using the aforementioned models to carry out calculations in order subsequently to operate and monitor the vehicle battery optimally.

The above method provides for ascertaining a charging profile, i.e., a curve of the charging current during a charging process during a specified charging period, by means of optimization and simulation by means of the thermal battery model. The aim of the optimization is to store as much charging energy as possible in the vehicle battery in the specified charging period while complying with the temperature limits by varying the charging current and while minimizing the degradation of the vehicle battery.

According to an example embodiment of the present invention, it can be provided that the optimization method generates charging current curves by creating compilations of charging current curve segments, wherein the charging current curve segments represent time segments of a linear or nonlinear current curve, wherein the compilation of charging current curve segments is carried out by random selection and/or by a genetic algorithm or other combinatorial optimization methods. Alternatively, the optimization method can also provide for scaling of a specified charging current curve.

As a result, the resulting charging current curve is not constant, but can be stepped, pulsed, partially linear or nonlinear, and is determined such that the highest amount of energy is stored in the vehicle battery in the specified charging period while complying with the boundary conditions for the battery temperature (temperature criterion). The state of charge at the charging start time, the starting battery temperature at the charging start time, and the specified charging period at the beginning of charging are taken into account in the optimization.

According to an example embodiment of the present invention, the at least one temperature criterion may include that a specified maximum battery temperature is not exceeded. In particular, the at least one temperature criterion may furthermore include that, in a phase after the start of the charging process, a gradient of the drop in battery temperature is not fallen below until the maximum battery temperature is reached.

In particular, according to an example embodiment of the present invention, the optimization method can result in charging current curves with strong variations in the charging current since the relationship between charging current, state of charge, power loss, and battery temperature can be very nonlinear.

According to an example embodiment of the present invention, it can be provided that the optimization method ascertains multiple charging current curves that have maximized storable charge quantities, wherein the charging current curve that causes the least degradation during the charging process is ascertained as the optimized charging current curve as the optimized charging profile.

In particular, the multiple charging current curves can cause maximized storable charge quantities that do not differ from one another by more than 5%.

According to an example embodiment of the present invention, if multiple charging current curves result, the charging current curve that, on the basis of an aging state model, causes the least degradation of the vehicle battery during the charging period is selected.

According to an example embodiment of the present invention, the optimization method can be based on a combinatorial optimization method in which different time segments of charging current curves with different current curves and different start and end charging currents can be provided, which curve segments are iteratively combined so that the resulting composite charging current curve, which represents a charging profile for achieving a maximum charge supply to the vehicle battery without exceeding the specified maximum battery temperature.

According to an example embodiment of the present invention, if the battery temperature at the start of the charging process is higher than the maximum battery temperature specified for the charging process, lower charging current segments can be provided, which charge the vehicle battery while the battery temperature is increased, but still allow the vehicle battery to cool down to a temperature below the maximum battery temperature. In this way, the charging currents can be dimensioned such that a temperature gradient of the drop in battery temperature is not fallen below within the first phase.

In detail, the above method of the present invention provides that, in the event of an upcoming charging process of a predetermined charging period, a starting state of charge at the time of the start of charging, and a battery temperature as well as, if applicable, a battery capacity and the battery type are transmitted to a central unit external to the vehicle or provided there. The central unit performs the optimization method in order to determine an optimal charging current curve. For this purpose, the temperature curve is used by means of the thermal battery model for the vehicle battery in question. The optimal charging current curve provides for storing a maximum charge quantity in the vehicle battery during the specified charging period. The maximum battery temperature should not be exceeded, if possible, or should be reduced below the maximum battery temperature as quickly as possible. For example, the optimization method can be used to simulate various charging current curves ascertained by combinatorics and to temporarily store the corresponding charging current curve when it reaches a maximum value of a charge quantity transferred to the vehicle battery in comparison to previous simulations. The specified maximum battery temperature must not be exceeded or, if applicable, a gradient of the drop in temperature must not be fallen below in the initial phase.

According to an example embodiment of the present invention, the optimization method ascertains the combinations of charging current curve segments, for example, by means of combinatorial methods, such as genetic algorithms or the like. The charging current curve segments are determined such that they completely fill the available specified charging period, and can be stretched or compressed in time if necessary.

According to an example embodiment of the present invention, by means of a battery model, the temperature curve and the charge quantity supplied are now determined for a charging current curve to be simulated. The charging current curve is temporarily stored as a candidate for a charging current curve if the temperature curve does not exceed the maximum battery temperature or if, during a time phase at the beginning of the charging process, the battery temperature does not fall below a gradient of the drop in battery temperature and the charge quantity supplied exceeds that of the previously stored charging current curves. If multiple candidates for charging current curves that can transfer comparable charge quantities to the vehicle battery are found in this way, they can subsequently be selected according to the degradation of the vehicle battery they cause. For this purpose, further battery variables such as the terminal voltage, the state of charge curve, and the temperature curve can be ascertained from the charging current curve by means of a specified aging state model, and the degradation at the end of the charging period can be simulated by means of an electrochemical aging state model. The charging current curve with the lower degradation is then selected. However, for charging electric commercial vehicles, reducing degradation is only a secondary objective, while supplying maximum electrical energy to the vehicle battery while complying with the thermal conditions is a priority.

According to an example embodiment of the present invention, once the optimized charging current curve has been ascertained in the central unit, it is communicated back to the vehicle and used there for the upcoming charging process.

According to an example embodiment of the present invention, it can be provided that the method is performed in a central unit (cloud) remote from the vehicle and that the at least one optimized charging current curve as an optimized charging profile for performing the charging process is provided by transmitting the at least one optimized charging current curve to the vehicle in question.

According to a further aspect of the present invention, a device for performing the above method of the present invention is provided.

### BRIEF DESCRIPTION OF THE DRAWINGS

Example embodiments of the present invention are explained in more detail below with reference to the figures.

FIG. 1 is a schematic representation of a system for transmitting operating variable curves of vehicle batteries of a vehicle to a central unit, according to an example embodiment of the present invention.

FIG. 2 is a flowchart illustrating a method for filling operating variable curves during a period of data interruption, according to an example embodiment of the present invention.

FIG. 3 shows an exemplary artificial charging current curve from compiled charging current curve segments, according to an example embodiment of the present invention.

### DETAILED DESCRIPTION OF EXAMPLE EMBODIMENTS

The method according to the present invention is described below with reference to a vehicle battery in an electric truck. The method is performed in a central unit and makes it possible to monitor the vehicle battery on the basis of continuous time curves of the operating variables.

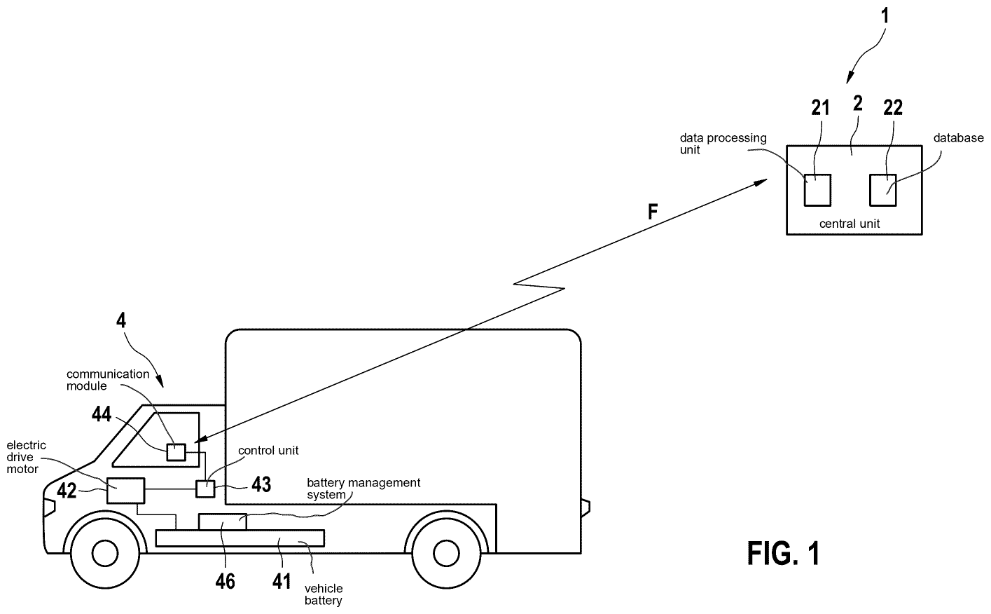

FIG. 1 shows a system 1 for optimizing and providing charging profiles/charging curves. FIG. 1 shows an electric commercial vehicle 4, which is in communication with the central unit 2.

The electric commercial vehicle 4 has a vehicle battery 41 as a rechargeable electrical energy store, an electric drive motor 42, and a control unit 43. The control unit 43 is connected to a communication module 44, which is suitable for transmitting data between the electric commercial vehicle 4 and a central unit 2 (a so-called cloud). The vehicle battery 41 has a battery management system 46, which provides data about the vehicle battery 41.

The electric commercial vehicle 4 sends a request to the central unit 2 to ascertain an optimal charging profile and, for this purpose, transmits information about a starting state of charge, an expected charging period, and a battery temperature (current or predicted for the time of the beginning of charging). Furthermore, operating variables F, which at least specify variables necessary for monitoring the vehicle battery 41, can be transmitted for battery monitoring.

The operating variables F can be time series of a battery current, of a battery voltage, of a battery temperature, and of a state of charge (SOC) at the pack level, module level, and/or cell level. The operating variables F are captured in a fast time grid of 1 Hz to 100 Hz and can be regularly transmitted to the central unit 2 in uncompressed and/or compressed form.

For example, a battery model that describes the electrochemical behavior of the vehicle battery 41 by means of a system of differential equations can be evaluated on the basis of the received operating variable curves F for the vehicle battery 41. Internal battery states, in particular equilibrium states and, if applicable, kinetic states, can be ascertained therefrom in a conventional manner. The system of differential equations can model these battery states by means of a time integration method and can provide a relationship between operating variable curves of the device battery, namely a battery current, a battery voltage, a battery temperature, and a state of charge of the device battery, and the internal battery state. Such electrochemical battery models are described, for example, om U.S. Patent Application Publication Nos. US 2016/023,566, US 2016/023,567, and US 2020/150,185.

An aging state can also be ascertained in a conventional manner from the internal battery states and/or, if applicable, by means of a separate model based on a system of differential equations. Alternatively, the aging state can also be ascertained by means of an aging state model that is also designed as a system of differential equations and uses time series integration to ascertain the aging state on the basis of the time curves of the operating variables.

The central unit 2 has a data processing unit 21, in which the method described below can be performed, and a database 22 for storing data points, model parameters, states, operating variable curves, and the like.

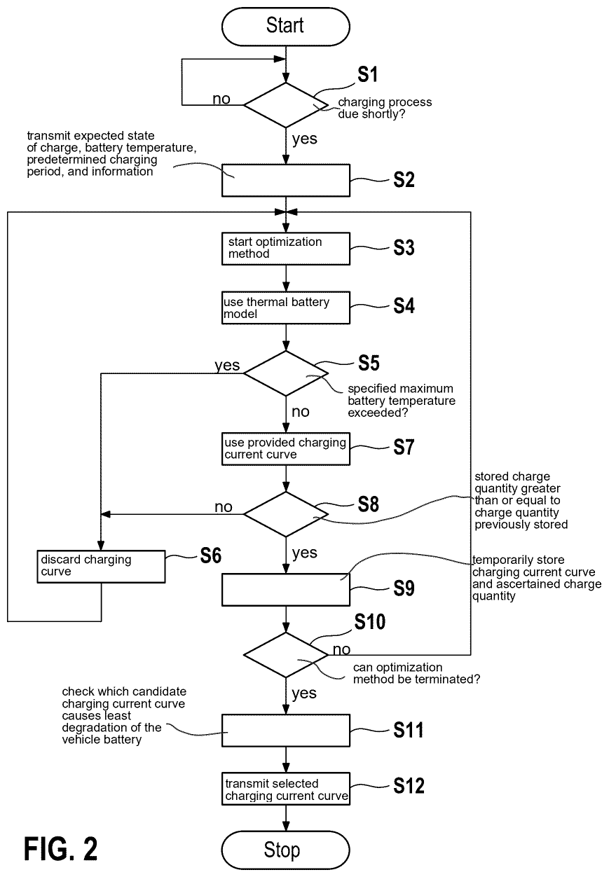

FIG. 2 schematically shows, by means of a flowchart, a procedure for performing a charging process for the electric commercial vehicle 4, which is to charge a maximum amount of energy within a specified charging period.

For this purpose, in step S1, it is checked whether a charging process is due shortly. If this is the case (alternative: Yes), the method continues with step S2; otherwise (alternative: No), it returns to step S1.

In step S2, in the electric commercial vehicle 4, the expected state of charge at the beginning of charging, the battery temperature, in particular the expected battery temperature at the beginning of charging, and the predetermined charging period as well as, if applicable, information about the available battery capacity and the battery type are transmitted to the central unit. The expected state of charge at the beginning of charging can be estimated by estimating the time until the beginning of charging and the average energy consumption per unit of time.

Alternatively, the energy consumption can also be estimated on the basis of the distance still to be covered to the charging point, and the expected state of charge at the beginning of charging can be ascertained depending on the current state of charge. The battery temperature provided can be the current battery temperature or a predictively ascertained battery temperature.

Starting with step S3, an optimization method based on a thermal battery model is started in the central unit.

The thermal battery model is provided for the specific battery type and makes it possible to determine a power loss or, directly, a battery temperature on the basis of a starting battery temperature, an ambient temperature if applicable, a time curve of a charging current. If the power loss is determined, the battery temperature can be determined therefrom by means of a heat balance model in a conventional manner by taking into account thermal contact resistances and the like. By means of the thermal battery model, a curve of the battery temperature can thus be modeled on the basis of a specific starting battery temperature, a state of charge that determines the power loss, and a time curve of the charging current during the charging process.

In addition to the power loss due to the charging current, the thermal battery model can also take into account the effect of battery cooling for the battery type in question and the ambient temperature.

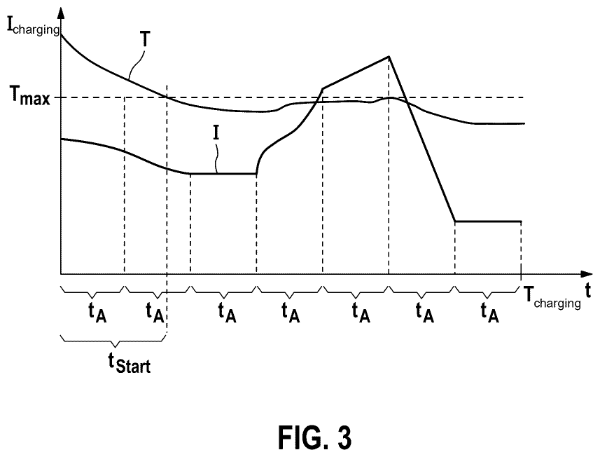

The optimization method now provides in step S3 that specified charging current curve segments, which specify time segments ta of linear curves of a charging current or of nonlinear curves of a charging current, are combined. The time segments ta can have the same or different durations. This can result in constant, pulsed, stepped, or other linear or nonlinear time curves of the charging current for the predetermined charging period T_{charging}. An example of such a charging current curve I_{charging} is shown in FIG. 3. Such battery current curves are determined combinatorially or in other ways.

In step S4, the thermal battery model is used to model a corresponding battery temperature curve depending on the provided charging current curve.

In step S5, it is checked whether a specified maximum battery temperature Tₘₐₓ is exceeded during the battery temperature curve or whether a gradient of the drop in battery temperature is not fallen below during an initial phase tₛₜₐᵣₜ at the beginning of the charging process (especially if the battery temperature is higher than the maximum battery temperature due to an excessively high starting battery temperature). If this is the case (alternative: Yes), the previously ascertained charging current curve is discarded in step S6 and the method returns to step S3.

If possible, the charging current curve segments to be combined are thus selected such that a maximum battery temperature Tₘₐₓ is not exceeded. If the battery temperature at the beginning of the charging process is above the maximum battery temperature, a minimum gradient of the drop in battery temperature must be maintained until the maximum battery temperature is reached. In step S3, the optimization method can exchange charging current curve segments, stretch or compress them in time, and scale the current curve present in the charging current curve segments by a factor and thus generate a suitable charging current curve.

Otherwise (alternative: No), the provided charging current curve is used in step S7 to ascertain the charge quantity stored in the vehicle battery 41 thereby. This is generally carried out by integrating the charging current over time.

In step S8, it is checked whether the stored charge quantity is greater than or equal to a charge quantity previously stored for a different charging current curve or whether it is not below a charge quantity limit value, which is below the previously ascertained maximum charge quantity by a specified tolerance amount. If this is the case (alternative: Yes), the method continues with step S9. Otherwise (alternative: No), the method returns to step S6.

In step S9, the charging current curve and the ascertained charge quantity are temporarily stored.

In step S10, it is checked whether the optimization method can be terminated. This may be the case, for example, if the ascertained charge quantity/quantities exceed a specified threshold value.

If the optimization method converges, it is thus possible to ascertain multiple candidates for charging current curves that are identical with regard to the maximized charge supply or that differ from one another only by less than the specified tolerance amount.

If the optimization method is to be terminated (alternative: Yes), the method continues with step S11. Otherwise (alternative: No), the method returns to step S3.

In step S11, for the multiple ascertained charging current curves with approximately equal charge quantities, it is checked which of the candidate charging current curves causes the least degradation of the vehicle battery 41.

For this purpose, a time-series-based aging state model can be used, which in particular evaluates the charging current curve of each candidate. For this purpose, for example, a battery model (equivalent circuit model) can be used to ascertain a terminal voltage curve from the charging current curve and the resulting battery temperature curve, and to ascertain a state of charge curve by integration. From the curves of these operating variables, an aging state at the end of the predetermined charging period can be ascertained in an aging state model based on the evaluation of time-series signals.

In particular, the simulated operating variable curve obtained in this way can be evaluated by means of a time-series-based aging state model, which is used to determine a modeled aging state at the end of the charging period. The modeled aging state can be ascertained in a conventional manner by evaluating the operating variable curves by means of the aging model. For this purpose, an electrochemical battery model can be used to model internal battery states and to determine an aging state therefrom. The electrochemical battery model is based on a system of differential equations with a plurality of nonlinear differential equations. The operating variable data make it possible to model a current battery state by means of a time integration method. Such electrochemical battery models are described, for example, in U.S. Patent Application Publication Nos. US 2016/023,566, US 2016/023,567, and US 2020/150,185. The degradation can be determined by calculating the difference between the aging state at the beginning of the charging period and the aging state at the end of the charging period.

The candidate charging current curve that causes the least degradation is then selected.

This selected charging current curve is now transmitted to the vehicle in step S12 and used there in the battery management system for the upcoming charging process.

1-11. (canceled)

12. A computer-implemented method for providing an optimized charging profile for a charging process of a vehicle battery of an electric commercial vehicle with a known start time of the charging process and a known charging period, the method comprising the following steps:
providing a starting state of charge at the start of a charging process, a starting battery temperature, and the charging period;
performing an optimization method for ascertaining at least one optimized charging current curve, wherein the optimization maximizes a charge quantity storable in the vehicle battery within the charging period and satisfies at least one temperature criterion based on a simulated battery temperature curve, wherein the battery temperature curve is simulated using a specified thermal battery model depending on the starting state of charge, the starting battery temperature, and the charging current curve; and
providing the at least one optimized charging current curve as an optimized charging profile for performing the charging process.

13. The method according to claim 12, wherein the optimization method ascertains multiple charging current curves that have maximized storable charge quantities, wherein the charging current curve that causes a least degradation during the charging process is ascertained as the optimized charging current curve as the optimized charging profile.

14. The method according to claim 13, wherein the multiple charging current curves cause storable charge quantities that do not differ from one another by more than 5%.

15. The method according to claim 11, wherein the at least one temperature criterion includes that a specified maximum battery temperature is not exceeded.

16. The method according to claim 15, wherein the at least one temperature criterion includes that, in a phase after a start of the charging process, a gradient of the drop in battery temperature is not fallen below until the maximum battery temperature is reached.

17. The method according to claim 11, wherein the optimization method generates charging current curves by creating compilations of charging current curve segments, wherein the charging current curve segments represent time segments of a linear or nonlinear current curve, wherein the compilation of charging current curve segments is carried out by random selection and/or by a genetic algorithm or a combinatorial optimization method.

18. The method according to claim 11, wherein the optimization method generates charging current curves by scaling a specified charging current curve.

19. The method according to claim 11, wherein the method is performed in a central unit remote from the vehicle and the at least one optimized charging current curve as an optimized charging profile for performing the charging process is provided by transmitting the at least one optimized charging current curve to the vehicle.

20. A device configured to provide an optimized charging profile for a charging process of a vehicle battery of an electric commercial vehicle with a known start time of the charging process and a known charging period, the device configured to:
provide a starting state of charge at the start of a charging process, a starting battery temperature, and the charging period;
perform an optimization method for ascertaining at least one optimized charging current curve, wherein the optimization maximizes a charge quantity storable in the vehicle battery within the charging period and satisfies at least one temperature criterion based on a simulated battery temperature curve, wherein the battery temperature curve is simulated using a specified thermal battery model depending on the starting state of charge, the starting battery temperature, and the charging current curve; and
provide the at least one optimized charging current curve as an optimized charging profile for performing the charging process.

21. A non-transitory machine-readable storage medium on which are stored commands for providing an optimized charging profile for a charging process of a vehicle battery of an electric commercial vehicle with a known start time of the charging process and a known charging period, the commands, when executed by at least one data processing unit, causing the at least one data processing unit to perform the following steps:
providing a starting state of charge at the start of a charging process, a starting battery temperature, and the charging period;
performing an optimization method for ascertaining at least one optimized charging current curve, wherein the optimization maximizes a charge quantity storable in the vehicle battery within the charging period and satisfies at least one temperature criterion based on a simulated battery temperature curve, wherein the battery temperature curve is simulated using a specified thermal battery model depending on the starting state of charge, the starting battery temperature, and the charging current curve; and
providing the at least one optimized charging current curve as an optimized charging profile for performing the charging process.
